(19) United States
(12) Patent Application Publication
(10) Pub. No.: US 2024/0193225 A1
(43) Pub. Date: Jun. 13, 2024

(54) SYNTHESIS FOR MATRIX MULTIPLICATION USING A DATA PROCESSING ARRAY

(71) Applicant: Xilinx, Inc., San Jose, CA (US)

(72) Inventors: Srijan Tiwary, Chhattisgarh (IN); Fan Zhang, San Jose, CA (US); Sumanta Datta, Hyderabad (IN); Aman Gayasen, Hyderabad (IN)

(73) Assignee: Xilinx, Inc., San Jose, CA (US)

(21) Appl. No.: 18/065,491

(22) Filed: Dec. 13, 2022

(51) Int. Cl. G06F 17/16; G06F 7/487; G06F 7/72

(52) U.S. Cl. CPC G06F 17/16; G06F 7/4876; G06F 7/727

(57) ABSTRACT

Parameters defining a matrix multiply operation to be implemented in a data processing array can be received. A formulation of the matrix multiply operation is generated based on the parameters. A matrix multiply solution is determined for performing the matrix multiply operation in the data processing array. The matrix multiply solution specifies a spatial and temporal partitioning of the matrix multiply operation for implementation in the data processing array. Synthesizable program code is generated that defines an interface for the data processing array based on the matrix multiply solution. The interface is configured to partition and transfer input data to the data processing array from an external memory and convey output data from the data processing array to the external memory.

### TECHNICAL FIELD

This disclosure relates to integrated circuits that include a data processing array and, more particularly, to implementing matrix multiply operations using a data processing array of an integrated circuit.

### BACKGROUND

Matrix multiply operations are utilized in many different computing environments including, but not limited to, machine learning, image processing, computer vision, virtual and/or extended reality, and genetic analysis. Implementing matrix multiply operations in hardware such as an integrated circuit can be a complex task. Given modern workloads, in many cases, the size of the operand matrices is so large that the entirety of even one of the operant matrices cannot fit within the on-chip memory of the integrated circuit or within the memory of the particular computing resource tasked with performing the matrix multiply operation. These types of limitations require that the matrix multiply operation be subdivided into many smaller matrix multiply operations such that the original matrix multiply operation is performed in piecemeal fashion.

Subdividing the operation to be performed is a complex and time-consuming process. An acceptable solution to the problem is highly dependent on the architecture of the target hardware. An inefficient subdivision of the matrix multiply operation that fails to adequately account for the architecture of the target hardware often results in reduced operational and computational efficiency (e.g., reduced performance) of the target hardware.

### SUMMARY

In one or more example implementations, a method includes receiving, using computer hardware, parameters defining a matrix multiply operation to be implemented in a data processing array. The method includes generating, using the computer hardware, a formulation of the matrix multiply operation based on the parameters. The method includes determining, using the computer hardware, a matrix multiply solution for performing the matrix multiply operation in the data processing array. The matrix multiply solution specifies a spatial and temporal partitioning of the matrix multiply operation for implementation in the data processing array. The method includes generating, using the computer hardware, synthesizable program code defining an interface for the data processing array based on the matrix multiply solution. The interface is configured to partition and transfer input data to the data processing array from an external memory and convey output data from the data processing array to the external memory.

The foregoing and other implementations can each optionally include one or more of the following features, alone or in combination. Some example implementations include all the following features in combination.

In some aspects, the formulation is a Satisfiability Modulo Theory (SMT) formulation and the determining the matrix multiply solution is performed by executing an SMT solver with the SMT formulation provided as input.

In some aspects, the method includes synthesizing the synthesizable program code to generate a circuit design for the interface for the data processing array.

In some aspects, for the matrix multiply operation, the input data corresponds to a plurality of operand matrices and the output data corresponds to a result matrix. The synthesizable program code defines a number of input ports configured to convey the input data from each operand matrix of the plurality of operand matrices and a number of output ports for conveying the output data of the result matrix.

In some aspects, the input ports are configured to load corresponding batches of data of each operand matrix from the external memory to the data processing array based on the spatial and temporal partitioning for each operand matrix.

In some aspects, the synthesizable program code defines accumulation circuitry for the output ports.

In some aspects, the accumulation circuitry is configured to accumulate partial results on the output ports to generate a result batch for each corresponding set of batches of data from the operand matrices.

In some aspects, the method includes generating a dataflow graph (DFG) based on the matrix multiply solution. The DFG may be compiled into an application that is executable by the data processing array to perform the matrix multiply operation. The application, as executed in the data processing array, is configured based on the matrix multiply solution and is configured to communicate with the interface as implemented in circuitry.

In one or more example implementations, a system includes one or more hardware processors configured and/or programmed to initiate operations as described within this disclosure.

In one or more example implementations, a computer program product (e.g., an apparatus and/or system) includes one or more computer readable storage mediums having program instructions embodied therewith. The program instructions are executable by computer hardware, e.g., a hardware processor, to cause the computer hardware to initiate and/or execute operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates an example implementation of a data processing system for use with the inventive arrangements described within this disclosure.

FIG. 2 illustrates an example implementation of the General Matrix Multiply (GEMM) framework of FIG. 1.

FIG. 3 illustrates an example of the matrix multiply operation to be performed and also illustrates spatial partitioning.

FIG. 4 illustrates temporal partitioning of the matrix multiply operation illustrated in FIG. 3.

FIG. 5 illustrates an example method of operation for the GEMM framework executed by the data processing system of FIG. 1.

FIG. 6 illustrates an example of an integrated circuit including a data processing array.

FIG. 7 illustrates an example implementation of a GEMM application in a data processing array.

FIGS. 8A, 8B, and 8C illustrate example partitions of matrices for a matrix multiply operation.

FIG. 9 illustrates an example of an accumulation circuit that may be generated based on the matrix multiply solution determined by a Satisfiability Modulo Theories (SMT) solver.

FIG. 10 illustrates an example circuit architecture implementing a matrix multiply operation in accordance with the inventive arrangements.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to integrated circuits that include a data processing array and, more particularly, to implementing matrix multiply operations using a data processing array of an integrated circuit. In accordance with the inventive arrangements described within this disclosure, methods, systems, and computer program products are provided that are capable of automatically generating a solution for implementing a matrix multiply operation in hardware using a data processing array. The solution specifies a partitioning of the matrix multiply operation so that target hardware, e.g., an IC including a data processing array, is able to efficiently perform the matrix multiply operation. The partitioning may include a spatial and a temporal partitioning.

In one aspect, based on the solution, high-level synthesis (HLS) code may be generated. The HLS code specifies an interface for the data processing array that is configured to transfer data from an external memory to the data processing array and transfer results generated by the data processing array to the external memory. The interface, upon physical realization in the target hardware, transfers data from the operand matrices stored in external memory to the data processing array in accordance with the partitioning that is determined. The interface, upon physical realization in the target hardware, further performs any reconstruction of the result matrix in the external memory. For example, the interface implements any accumulation of partial results generated by the data processing array for storage into the external memory.

In another aspect, based on the solution, a dataflow graph (DFG) specifying the executable kernels configured to implement the partitioned matrix multiply operation may be generated. The DFG may be compiled into an application that is executable by the data processing array to perform the matrix multiply operation. The application, as executed in the data processing array, is configured based on the solution and is configured to communicate with the interface as implemented in circuitry.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

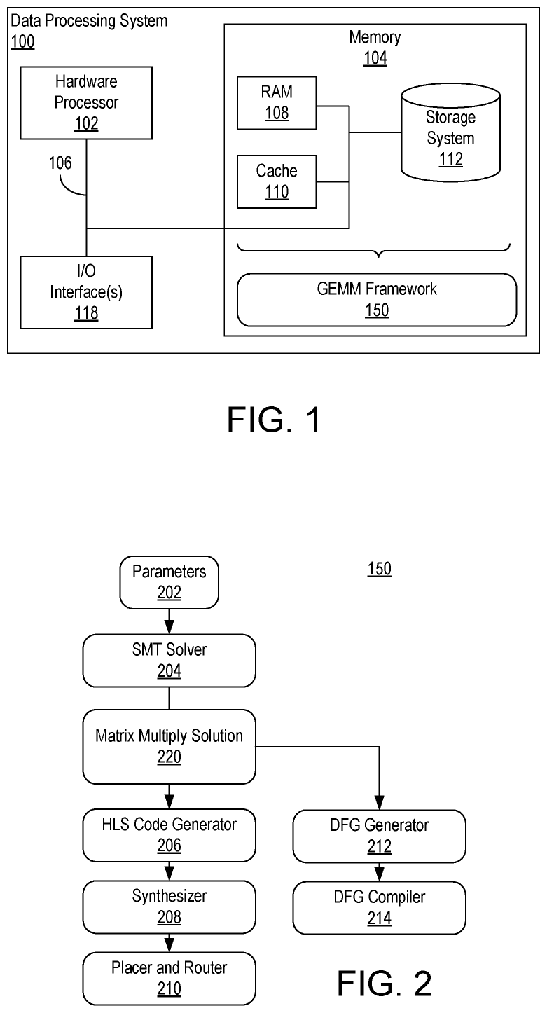

FIG. 1 illustrates an example implementation of a data processing system 100. As defined herein, the term “data processing system” means one or more hardware systems configured to process data, each hardware system including at least one hardware processor and memory, wherein the hardware processor is programmed with computer-readable instructions that, upon execution, initiate operations.

In the example of FIG. 1, data processing system 100 is capable of executing a General Matrix Multiply (GEMM) framework 150. In executing GEMM framework 150, various constraints from a user are received and used to generate a matrix multiply solution. In general, the matrix multiply solution breaks a large matrix multiply operation into smaller matrix multiply operations that may be performed on the target hardware. Based on this partitioning, as expressed in the matrix multiply solution, GEMM framework 150 is capable of generating a DFG. The DFG may be compiled (e.g., synthesized) to create an application that is executable by the data processing array.

Further, GEMM framework 150 is capable of generating HLS code that specifies an interface for the application as executed by the data processing array. GEMM framework 150 is capable of performing operations that transform the HLS code into circuitry, where the circuitry is configured to transfer data correctly from a source external memory to the data processing array and transfer computed data from the data processing array out to a destination external memory. The source and destination external memories may be the same memory or different memories. Further, the circuitry reconstructs the result matrix.

Data processing system 100 can include a hardware processor 102, a memory 104, and a bus 106 that couples various system components including memory 104 to hardware processor 102. Hardware processor 102 may be implemented as one or more circuits capable of carrying out instructions contained in program code. The circuit(s) may be implemented as an integrated circuit or embedded in an integrated circuit. In this regard, hardware processor 102 may be implemented as one or more hardware processors. In an example, hardware processor 102 is implemented as a central processing unit (CPU). Hardware processor 102 may be implemented using a complex instruction set computer architecture (CISC), a reduced instruction set computer architecture (RISC), a vector processing architecture, or other known architectures. Example hardware processors include, but are not limited to, hardware processors having an x86 type of architecture (IA-32, IA-64, etc.), Power Architecture, ARM processors, and the like.

Bus 106 represents one or more of any of a variety of communication bus structures. By way of example, and not limitation, bus 106 may be implemented as a Peripheral Component Interconnect Express (PCIe) bus.

Data processing system 100 typically includes a variety of computer system readable media. Such media may include computer-readable volatile and non-volatile media and computer-readable removable and non-removable media. Memory 104 can include computer-readable media in the form of volatile memory, such as random-access memory (RAM) 108 and/or cache memory 110.

Data processing system 100 also can include other removable/non-removable, volatile/non-volatile computer storage media. By way of example, storage system 112 can be provided for reading from and writing to a non-removable, non-volatile magnetic and/or solid-state media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 106 by one or more data media interfaces. Memory 104 is an example of at least one computer program product.

Memory 104 is capable of storing computer-readable program instructions that are executable by processor 102. For example, the computer-readable program instructions can include an operating system, one or more application programs, other program code, and program data. Hardware processor 102, in executing the computer-readable program instructions, is capable of performing the various operations described herein that are attributable to a computer.

In one or more example implementations, memory 104 may store a GEMM framework 150. In the examples, GEMM framework 150 is implemented as computer-readable program instructions that are executable by hardware processor 102. In executing GEMM framework 150, hardware processor 102 is capable of, e.g., configured to, perform the various operations described within this disclosure relating to implementing matrix multiply operations using a data processing array of an IC. In general, GEMM framework 150 is capable of generating a matrix multiply solution that specifies a spatial and temporal partitioning of the matrix multiply operation. GEMM framework 150 further is capable of generating a description of an interface for the data processing array specified as high-level synthesis (HLS) code based on the generated matrix multiply solution. The interface, as defined by the HLS code, when implemented in the target hardware, is capable of partitioning and transferring input data from an external memory to the data processing array. Further, the interface is capable of conveying output data from the data processing array to the external memory. As discussed, GEMM framework 150 may also generate a DFG based on the matrix multiply solution and further process the DFG to generate an application that is executable by the data processing array to perform the matrix multiply operation in accordance with the matrix multiply solution so generated.

It should be appreciated that data items used, generated, and/or operated upon by data processing system 100 are functional data structures that impart functionality when employed by data processing system 100. As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a hardware processor.

Data processing system 100 may include one or more Input/Output (I/O) interfaces 118 communicatively linked to bus 106. I/O interface(s) 118 allow data processing system 100 to communicate with one or more external devices and/or communicate over one or more networks such as a local area network (LAN), a wide area network (WAN), and/or a public network (e.g., the Internet). Examples of I/O interfaces 118 may include, but are not limited to, network cards, modems, network adapters, hardware controllers, etc. Examples of external devices also may include devices that allow a user to interact with data processing system 100 (e.g., a display, a keyboard, and/or a pointing device) and/or other devices such as accelerator card.

Data processing system 100 is only one example implementation. Data processing system 100 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network.

The example of FIG. 1 is not intended to suggest any limitation as to the scope of use or functionality of example implementations described herein. Data processing system 100 is an example of computer hardware that is capable of performing the various operations described within this disclosure. In this regard, data processing system 100 may include fewer components than shown or additional components not illustrated in FIG. 1 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

FIG. 2 illustrates an example implementation of GEMM framework 150 of FIG. 1. In the example, GEMM framework 150 includes a Satisfiability Modulo Theories (SMT) solver 204, a High-Level Synthesis (HLS) code generator 206, a synthesizer 208, and placer and router 210. GEMM framework 150 also can include a DFG generator 212 and a DFG compiler 214.

It should be appreciated that while GEMM framework 150 is shown to include the aforementioned components, in other example implementations, certain components may be excluded. In such cases, GEMM framework 150 may generate certain results such as a matrix multiply solution 220 that may be provided to other Electronic Design Automation (EDA) tools that provide the features excluded from GEMM framework 150. For example, in some implementations, HLS code generator 206, synthesizer 208, placer and router 210, DFG generator 212, and/or DFG compiler 214 may be omitted and implemented instead by other EDA tools that are configured to interoperate with GEMM framework 150.

SMT solver 204 is a computer program that is capable of determining whether a given mathematical formula is one that is solvable or satisfiable. In the examples described herein, the mathematical formula, referred to as an SMT formulation, defines a particular matrix multiply partitioning problem to be solved in order to implement the matrix multiply operation in the target hardware. The SMT formulation may include one or more expressions, constraints, and variables. SMT solver 204 determines whether a set of values for the variables exists that satisfies the expressions and constraints (e.g., makes the SMT formulation true).

In general, an SMT solver is similar to a Boolean Satisfiability (SAT) Solver, but provides greater capabilities in that the SMT solver is capable of handling more complex mathematical expressions that involve real numbers, integers, and/or various data structures such as lists, arrays, bit vectors, and strings. Examples of SMT solvers include, but are not limited to, the Z3 Theorem Prover available from Microsoft® of Redmond, Washington and the cvc5 open source SMT solver.

HLS Code Generator 206 is program code that is capable of generating a specification for an interface based on matrix multiply solution 220 determined by SMT solver 204. The specification is specified, or written, in a high-level programming language code as source code that is synthesizable. The interface is for a data processing array. The source code may be specified in any of a variety of different high-level programming languages including, but not limited to, C/C++, SystemC, MATLAB code, or the like.

Synthesizer 208 is program code that, upon execution by hardware processor 102, is capable of transforming a high-level specification of a system, e.g., the HLS code output from HLS code generator 206, into a register-transfer level (RTL) design (e.g., a circuit design). The RTL design may be specified in a hardware description language. Placer and router 210 is capable of performing placement and routing on a circuit design for implementation in particular target hardware. Placement refers to the process of assigning elements of the synthesized design to particular instances of circuit blocks and/or resources having specific locations on the target hardware. Routing refers to the process of selecting or implementing particular routing resources, e.g., wires and/or other interconnect circuitry, to electrically couple the various circuit blocks of the target IC after placement of the synthesized design.

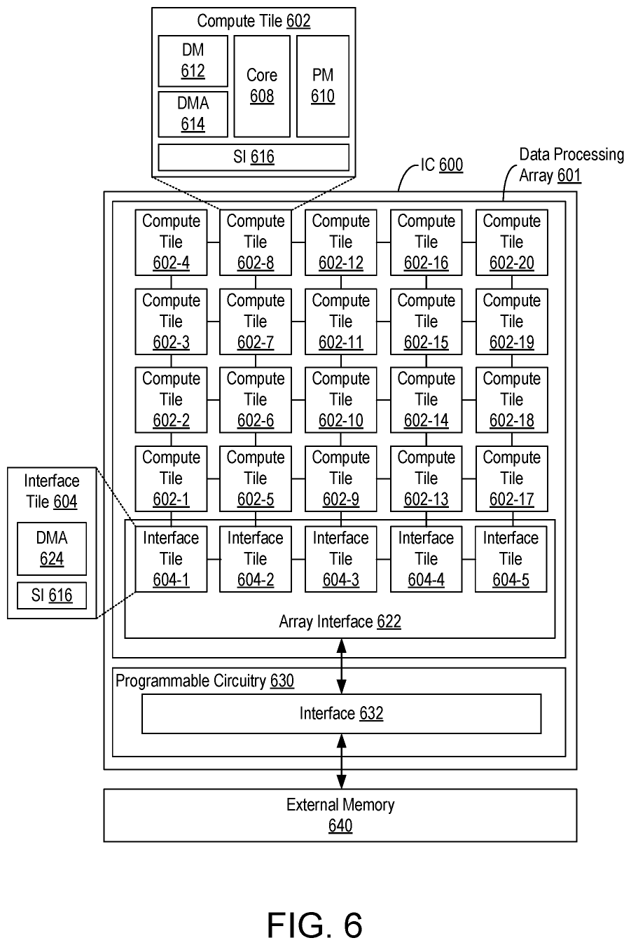

In some example implementations, the resulting design, having been processed through placement and routing, may be translated into configuration data that may be loaded into the target hardware (e.g., an IC), where the loading of the configuration data physically realizes the placed and routed circuit design in the target hardware. An example of target hardware is described within this disclosure in connection with FIG. 6.

As illustrated, matrix multiply solution 220 may also be provided to DFG generator 212. DFG generator 212 is capable of generating a DFG specified in a high-level programming language. The DFG specifies an application that, when implemented in the data processing array, performs the matrix multiply operation. The DFG may include, or reference, one or more component instances from a hardware library package. For example, the DFG may specify a graph, e.g., one or more interconnected sub-graphs, that instantiates components of the hardware library package (e.g., GEMM components) and defines how the one or more component instances are connected. DFG compiler 214 is capable of compiling the DFG to generate executable program code (e.g., object code specified as one or more binary files) that is executable by compute tiles of the data processing array.

A “hardware library package” refers to an assemblage of files and information about those files that is usable to program or configure a hardware resource as available on an IC. A hardware library package may be specified in a high-level programming language and may be tailored to a specific hardware resource. For example, the hardware library package may be specified using object-oriented source code such as templatized C++ source code. The hardware library package encapsulates commonly used functionality for a particular field of endeavor or a particular domain. As an illustrative and non-limiting example, a hardware library package for digital signal processing may include a software-based library component for implementing GEMM in a data processing array of an IC.

Prior to describing the operation of GEMM framework 150, the following description is helpful in defining matrix multiply solution 220 that is to be generated. For purposes of discussion, consider the expression A×B=C to be implemented in hardware where the two matrices A and B are operand (e.g., input) matrices and matrix C is the result or product matrix (e.g., the output).

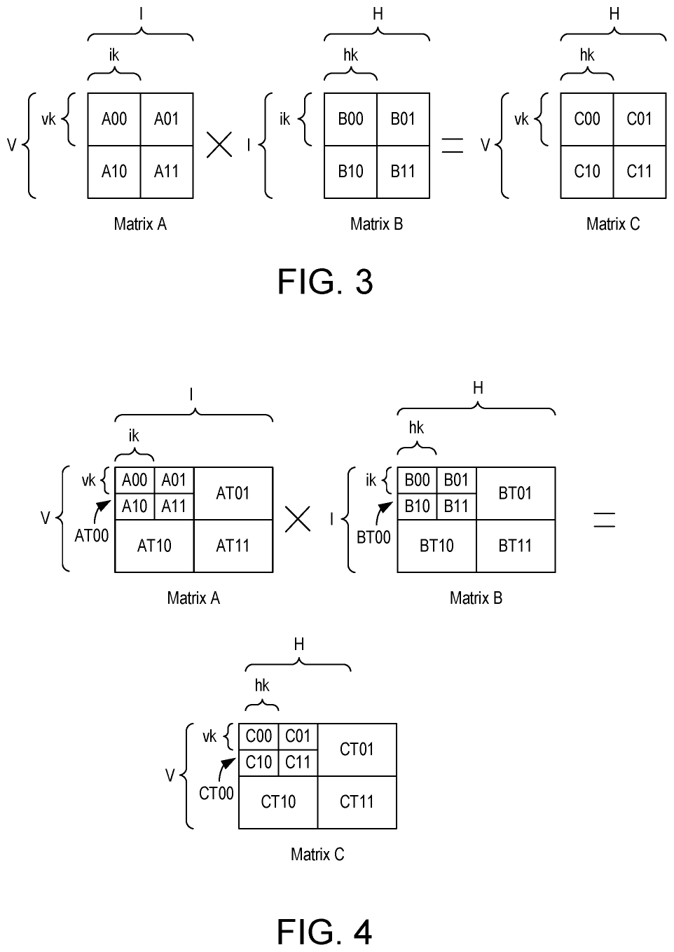

FIG. 3 illustrates an example of the matrix multiply operation to be performed and also illustrates an example of spatial partitioning. In the example of FIG. 3, matrix A has dimensions of V×I. Matrix B has dimensions of I×H. Matrix C has dimensions of V×H. In this example, the size of each of matrix is large enough that the entirety of a single matrix is too large to fit within on-chip memory of the target hardware to perform the matrix multiply operation. Thus, matrices A and B cannot be multiplied as one. Rather, the data processing array is only able to compute portions of the matrix multiply operation at a time. The size of the portion calculated depends on the data memory available in the data processing array for storing input data and output data.

In the example of FIG. 3, each dimension is divided into spatial partitions. Referring to matrix A, the V dimension is divided into size of vk and the I dimension is divided into size of ik. The number of partitions (e.g., spatial partitions) on the V dimension is denoted as v_sp and the number of partitions on the I dimension is denoted as i_sp. The spatial partitions illustrated in FIG. 3 (e.g., A00, A01, A10, and A11, etc.) are made such that expressions 1 and 2 are satisfied for matrix A. As known, the “ceil” function returns the smallest integer that is greater than or equal to the argument.

v_sp=ceil(V/vk) (1)

i_sp=ceil(l/ik) (2)

In the case of matrix B, the I dimension is divided into size of ik and the H dimension is divided into size of hk. The number of partitions on the I dimension is denoted as i_sp and the number of partitions on the H dimension is denoted as h_sp. These spatial partitions are made such that expressions 3 and 4 are satisfied for matrix B.

i_sp=ceil(l/ik) (3)

h_sp=ceil(H/hk) (4)

The number of computing cores available to perform the matrix multiply operation in the data processing array is nCORES. Within this disclosure, as each compute tile includes a single core, the number of nCORES is equal to the number of compute tiles available to perform the matrix multiply operation. Accordingly, the spatial partitions of each dimension, e.g., v_sp, i_sp, and h_sp satisfy expression 5 below.

v_sp*i_sp*h_sp=nCORES (5)

Based on the spatial partitions defined for matrix A and matrix B, the partitions of result matrix C have dimension V×H and can be defined as vk and hk. Each partition of matrix C can be calculated as illustrated below in expressions 6, 7, 8, and 9.

C00=A00*B00+A01*B10 (6)

C01=A00*B01+A01*B11 (7)

C10=A10*B00+A11*B10 (8)

C11=A10*B01+A11*B11 (9)

This can be generalized into the form illustrated in expression 10 below. In the example of expression 10, the matrix C={Cᵥₕ} such that 0<=v<v_sp and 0<=h<h_sp. In expression 10, each smaller partition matrix multiplication Aᵥᵢ*Bᵥᵢ is performed in one compute tile (e.g., core) of the data processing array.

Cᵥₕ=Σᵢ₌₀ⁱ^{ₛₚ}⁻¹Aᵥᵢ*Bᵢₕ (10)

FIG. 4 illustrates temporal partitioning of the matrix multiply operation illustrated in FIG. 3. With the spatial partitioning, the maximum size of the matrix multiplication that can be performed at one time is limited by the number of compute tiles of the data processing array that are concurrently available for compute. Temporal partitioning allows the matrix multiply operation to be performed without any size limitations. Whereas spatial partitioning determines the amount or portion of the matrix multiply operation that may be performed in the data processing array at a given time (e.g., concurrently), temporal partitioning determines the number of iterations or portions of the matrix multiply operation that are performed over time given the spatial partitioning.

In the example of FIG. 4, each dimension is divided into temporal partitions. Referring to matrices A and B, there are up to v_tp number of temporal dimensions for dimension V, i_tp temporal partitions for dimension I, and h_tp temporal dimensions for dimension H. Each temporal partition is then again divided into spatial partitions as described in connection with FIG. 3. With temporal partitions of matrices A and B, the constraints of expressions 11, 12, and 13 must be satisfied.

V<=vk*v_sp*v_tp (11)

I<=ik*i_sp*i_tp (12)

H<=hk*h_sp*h_tp (13)

Based on the temporal partitions of A and B matrices, the result matrix C may be calculated as illustrated in expressions 14, 15, 16, and 17.

CT00=AT00×BT00+AT01×BT10 (14)

CT01=AT00×BT01+AT01×BT11 (15)

CT10=AT10×BT00+AT11×BT10 (16)

CT11=AT10×BT01+AT11×BT11 (17)

Expressions 14-17 may be generalized as illustrated in expression 18, where matrix C={CTₘₙ} such that 0<=m<v_tp and 0<=h<h_tp. In the example of expression 18, the ATₘᵢ*BTᵢₙ multiplication is implemented as the multiplication described in connection with the discussion of spatial partitioning with reference to FIG. 3. It should be appreciated that temporal partitioning does not change the number of compute tiles of the data processing array that are required. The number of compute tiles required for the matrix multiply operation is determined only by spatial partitioning.

CTₘₙ=Σᵢ₌₀ⁱ^{ₜₚ}⁻¹ATₘᵢ*BTᵢₙ (18)

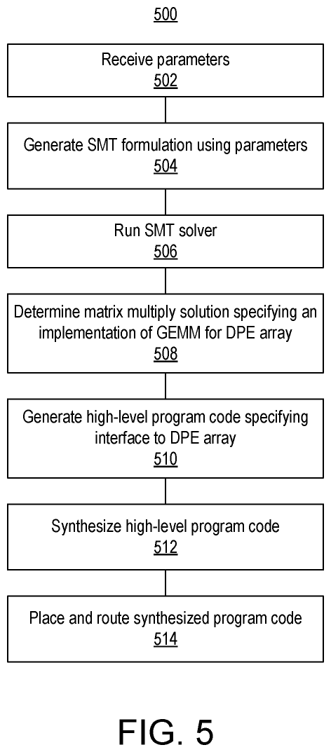

FIG. 5 illustrates an example method 500 of operation for GEMM framework 150 as executed by data processing system 100 of FIG. 1. Method 500 is described using the same or similar nomenclature used to describe the spatial and temporal partitioning of FIGS. 3 and 4.

In block 502, GEMM framework 150 receives one or more parameters 202. Examples of the parameters can include, but are not limited to, the datatype of each operand matrix for the GEMM operation. For purposes of discussion, consider the expression A×B=C to be implemented in hardware where the two matrices A and B are operand matrices and matrix C is the result or product matrix. The datatype of each respective matrix may be denoted as DatatypeA and DatatypeB. The parameters also may include the number of rows of the A matrix (DimA), the number of columns in the A matrix which is the number of rows in the B matrix (DimAB), and the number of columns in the B matrix (DimB). The parameters also can include a maximum number of compute tiles (e.g., cores) the user would like to use from the data processing array for performing the matrix multiply operation, the maximum number of compile tiles (e.g., cores) in one cascade chain, and the maximum amount of memory that is available to each compute tile (e.g., core) to perform the matrix multiply operation.

In developing an application intended to run or execute on target hardware, a designer may incorporate functions of a hardware library package, as previously discussed, into the application. The library component for implementing GEMM in hardware may take, as input, parameters 202. These parameters are required to implement the GEMM functionality. Parameters 202 may be used to partition the GEMM functionality using one or more kernels.

In one or more example implementations, parameters 202 are specified by a user. In one aspect, parameters 202 may be provided as values directly to SMT solver 204. In another aspect, parameters 202 may be specified by a user as parameters of the GEMM component of the hardware library package utilized by a user's GEMM application. For example, SMT solver 204 may be provided with the user's application for performing GEMM in a data processing array of the target hardware. The application may utilize the GEMM component having been parameterized with parameters 202. Parameters 202 may be stored as part of the GEMM component or otherwise stored in association with the GEMM component of the user's application. SMT solver 204 is capable of extracting parameters 202 from the application and/or GEMM component as the case may be.

In block 504, SMT solver 204 generates an SMT formulation using parameters 202. The SMT formulation is formed of a plurality of variables, parameters 202, and constraints defining relationships between the parameters 202 and the variables. The variables may include, for example, vk, ik, hk, v_sp, i_sp, h_sp, v_tp, i_tp, h_tp as previously discussed in connection with FIGS. 3 and 4. The granularity of the matrix multiply solution for each of the dimensions V, I, and H is defined as v_gran, i_gran and h_gran. These granularity factors depend upon how the GEMM components from the hardware library package for the data processing array are implemented and the datatypes of the operand matrices A and B.

The constraints included in the SMT formulation and used by SMT solver 204 include matrix size constraints, DPE compute tile utilization constraints, data memory constraints, and efficiency constraints. Matrix size constraints are illustrated below in expressions 19-21.

vk*v_sp*v_tp>=V (19)

ik*i_sp*i_tp>=I (20)

hk*h_sp*h_tp>=H (21)

DPE compute tile utilization constraints are illustrated below in expressions 22 and 23. In expression 23, the term “CascLenUpperBound” specifies the upper bound, in terms of number of DPE compute tiles, that may be used to form a cascade connection in the data processing array. Cascade connections are described in greater detail below.

v_sp*i_sp*h_sp<=nCORES (22)

i_sp<=CascLenUpperBound (23)

Data memory constraints are illustrated below in expressions 24 and 25.

vk*ik*sizeof(datatype(MatA))+ik*hk*sizeof(datatype(MatB))<=LOC_MEM (24)

vk*hk*sizeof(datatype(MatC))<=LOC_MEM (25)

Efficiency constraints are illustrated below in expressions 26, 27, 28, 29, 30, and 31. Expressions 28 and 29 correspond to different types of processing overhead. In the example of expressions 28 and 29, the values of 10 and 2 are biasing factors used to optimize the overhead (abbreviated as “oh”) of plAdd and t_iters, respectively, where the higher the value of one of the bias factors causes the SMT solver 204 to optimize towards that factor (e.g., the higher biasing factor).

ops==vk*ik*hk (26)

t_iters==v_tp*i_tp*h_tp (27)

plAdd_oh==(i_tp−1)*10 (28)

tlter_oh==(t_iters−1)*2 (29)

tot_oh==plAdd_oh+tlter_oh (30)

eff_ops==(ops*t_iters+tot_oh)*nCORES (31)

In each iteration of SMT solver 204, the constraints eff_ops and t_iters may be tightened as illustrated in the loop illustrated in the example of Listing 1. In the example of Listing 1, SMT solver 204 continues iterating until the constraints become unsatisfiable or SMT solver 204 times out.

### Example 1

```
While(solver.status != unsat) {
  eff_ops <= solver.eval(eff_ops);
  t_iters <= solver.eval(t_iters);
}
```

In block 506, SMT solver 204 begins operating on the SMT formulation to determine whether a solution exists. In block 508, SMT solver 204 determines matrix multiply solution 220 specifying an implementation of GEMM for the data processing array. Appreciably, in cases where SMT solver 204 is unable to determine a solution, e.g., where SMT solver 204 determines that constraints are unsatisfiable or times out, an error or notification may be generated indicating that no solution was found.

An example of matrix multiply solution 220 generated by SMT solver 204 is illustrated below in the example of Listing 2. Matrix multiply solution 220 specifies values for the matrix partition size, the number of spatial partitions, and the number of temporal partitions. Matrix multiply solution 220 also defines certain data processing array and/or compute tile configuration parameters that may be used to construct the result matrix C. Parameters specified by matrix multiply solution 220 may include the number of compute tiles of the data processing array to be used, the number of compute tiles in a cascade chain, the number of cascade chains, the number of input ports to be used for matrix A, the number of input ports to be used for matrix B, and the number of output ports to be used for matrix C.

### Listing 2

Matrix partition size: vk*ik*hk
Spatial partitions: v_sp*i_sp*h_sp
Temporal partitions: v_tp*i_tp*h_tp
Number of compute tiles in a cascade chain=i_sp
Number of cascade chains=v_sp*h_sp
Number of input ports of matrix A=v_sp*i_sp
Number of input ports of matrix B=i_sp*h_sp
Number of output ports of matrix C=v_sp*h_sp

In block 510, HLS code generator 206 generates high-level program code specifying an interface to the data processing array for the application (e.g., the compiled DFG previously discussed) based on matrix multiply solution 220. The high-level program code that is generated will specify attributes of the interface circuitry to be generated such as, for example, the number of input ports for each operand matrix and the number of output ports for the result matrix. Further, the high-level program code may specify accumulation circuitry and the operation of the accumulation circuitry. The high-level program code specifying the interface is generated based on matrix multiply solution 220, which specifies the spatial and temporal partitioning to be implemented to physically realize the matrix multiply operation in the target hardware.

In block 512, synthesizer 208 synthesizes the high-level program code description of the interface to generate a circuit design. In block 514, placer and router 210 perform placement and routing on the circuit design for the interface. In one or more other example implementations, GEMM framework 150 may include additional EDA tools (e.g., computer-based tools) that are capable of generating configuration data that, when loaded into the target hardware, physically realizes the interface as circuitry therein. It should be appreciated that a DFG may be generated from matrix multiply solution 220 and compiled as previously described in connection with FIG. 2.

FIG. 6 illustrates an example of an IC 600 including a data processing array 601. IC 600 is an example of target hardware in which a matrix multiply operation as described herein may be implemented. Data processing array 601 may be implemented as a plurality of interconnected tiles. The term “tile,” as used herein in connection with a data processing array, means a circuit block. The interconnected tiles of data processing array 601 include compute tiles 602 (e.g., 602-1, 602-2, 602-3, 602-4, 602-5, 602-6, 602-7, 602-8, 602-9, 602-10, 602-11, 602-12, 602-13, 602-14, 602-15, 602-16, 602-17, 602-18, 602-19, 602-20) and interface tiles 604 (e.g., 604-1, 604-2, 604-3, 604-4, 604-5). The tiles illustrated in FIG. 6 may be arranged in an array or grid and are hardwired.

Each compute tile 602 can include one or more cores 608, a program memory 610 (abbreviated as “PM”) 610, a data memory 612 (abbreviated as “DM”), a DMA circuit 614, and a stream interconnect 616 (abbreviated as “SI”). In one aspect, each core 608 is capable of executing program code stored in program memory 610. In one aspect, each core 608 may be implemented as a scalar processor, as a vector processor, as a scalar processor and a vector processor operating in coordination with one another, or as other circuitry that is capable of executing program code. In one or more other example implementations, cores 608 may be implemented as special purpose circuit blocks that do not execute program code but that are configurable to perform selected operations.

In one or more examples, each core 608 is capable of directly accessing the data memory 612 within the same compute tile 602 and the data memory 612 of any other compute tile 602 that is adjacent to the core 608 of the compute tile 602 in the up, down, left, and/or right directions. Core 608 sees data memories 612 within the same tile and in one or more other adjacent compute tiles as a unified region of memory (e.g., as a part of the local memory of the core 608). This facilitates data sharing among different compute tiles 602 in data processing array 601. In other examples, core 608 may be directly connected to data memories 612 in other compute tiles 602.

Cores 608 may be directly connected with adjacent cores 608 via core-to-core cascade connections (not shown). In one aspect, core-to-core cascade connections are unidirectional and direct connections between cores 608. In another aspect, core-to-core cascade connections are bidirectional and direct connections between cores 608. In general, core-to-core cascade connections allow the results stored in an accumulation register of a source core 608 to be provided directly to an input of a target or load core 608. This means that data provided over a cascade connection may be provided among cores directly with less latency since the data does not traverse the stream interconnect 616 and is not written by a first core 608 to data memory 612 to be read by a different core 608 having access to the same data memory 612.

In an example implementation, compute tiles 602 do not include cache memories. By omitting cache memories, data processing array 601 is capable of achieving predictable, e.g., deterministic, performance. Further, significant processing overhead is avoided since maintaining coherency among cache memories located in different compute tiles 602 is not required. In a further example, cores 608 do not have input interrupts. Thus, cores 608 are capable of operating uninterrupted. Omitting input interrupts to cores 608 also allows data processing array 601 to achieve predictable, e.g., deterministic, performance. It should be appreciated, however, that cores 608 may generate interrupts that may be provided to other systems or subsystems of IC 600.

In the example of FIG. 6, each compute tile 602 may be implemented substantially identically to include the same hardware components and/or circuitry. Further, data processing array 601 may include an array of compute tiles formed of any of a variety of processing elements such as digital signal processing engines, cryptographic engines, Forward Error Correction (FEC) engines, or other specialized hardware for performing one or more specialized tasks.

In one or more other examples, compute tiles 602 may not be substantially identical. In this regard, compute tiles 602 may include a heterogeneous mix of compute tiles 602 formed of two or more different types of processing elements. As an illustrative and nonlimiting example, different ones of compute tiles 602 may include processing elements selected from two or more of the following groups: digital signal processing engines, cryptographic engines, Forward Error Correction (FEC) engines, or other specialized hardware.

Interface tiles 604 form an array interface 622 for data processing array 601. Array interface 622 operates as an interface that connects tiles of data processing array 601 to other resources of IC 600. For example, array interface 622 may communicatively link compute tiles 602 with programmable circuitry 630 and/or one or more other subsystems such as, for example, a network-on-chip, a processor system including one or more hardened processor and/or processor cores, and/or other Application Specific IC (ASIC) blocks.

In the example of FIG. 6, array interface 622 includes a plurality of interface tiles 604 organized in a row. Interface tiles 604 can include a stream interconnect 616 and a DMA circuit 624. Interface tiles 604 are connected so that data may be propagated from one interface tile to another bi-directionally. Each interface tile 604 is capable of operating as an interface for the column of tiles directly above and is capable of interfacing such tiles with components and/or subsystems of the IC in which data processing array 601 is disposed.

Programmable circuitry 630 refers to circuitry used to rebuild reconfigurable digital circuits. Unlike hardwired circuitry, e.g., logic gates or other fixed function circuit blocks such as analog-to-digital converters or digital-to-analog converters, programmable logic has an undefined function at the time of manufacture. Prior to use, programmable logic must be programmed or “configured” using specialized data typically referred to as a configuration bitstream. Programmable logic is an example of programmable circuitry.

As illustrated, an interface 632 is implemented in programmable circuitry 630. Interface 632 may be generated in accordance with the example method described in connection with FIG. 5. That is, the high-level program code created from the matrix multiply solution determined by SMT solver 204 may be synthesized, placed and routed, and implemented within programmable circuitry 630.

As pictured, interface 632 communicatively links data processing array 601 with an external memory 640. External memory 640 is referred to as “external” in that the memory is not within data processing array 601. In one example, external memory 640 represents memory that is implemented in the same IC as data processing array 601. That is, external memory 640 may be an “on-chip” memory whether disposed on the same die as data processing array 601 or on a different die than data processing array 601 but within the same IC package though not included in data processing array 601. In another example, external memory 640 may be external to the IC in which data processing array 601 is implemented (e.g., off-chip). In that case, external memory 640 may be disposed on the same circuit board as IC 600 including data processing array 601.

In one or more example implementations, external memory 640 is implemented as a random-access memory. For example, external memory 640 may be implemented as a Double Data Rate, Synchronous Dynamic (DDR) RAM. In another example, external memory 640 may be implemented as a high-bandwidth memory (HBM). External memory 640 is large enough to store each of matrices A, B, and C.

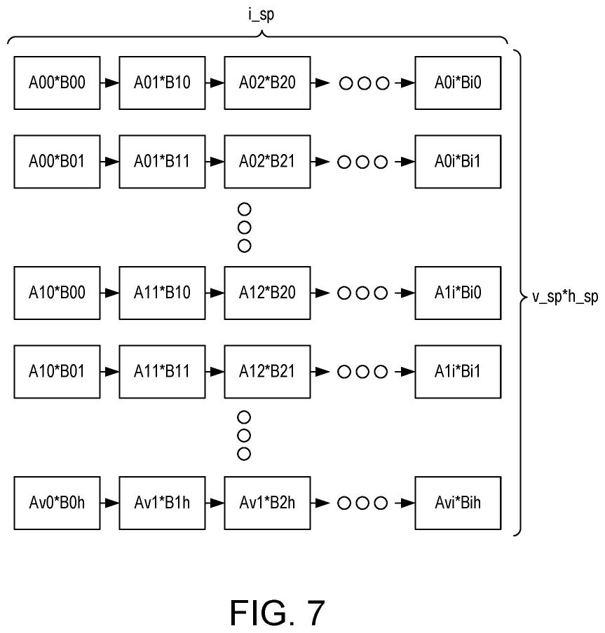

FIG. 7 illustrates an example implementation of a GEMM application as may be implemented in data processing array 601. In the example, each of the blocks representing a multiplication operation represents, and is performed by, a single compute tile and core (e.g., a compute tile 602 and the core 608 contained therein). In the example, each horizontal row of operations represents a cascade chain of compute tiles 602. In the example, the number of cascade chains (e.g., horizontal rows of compute tiles 602) and the number of compute tiles 602 in each cascade chain is specified by the matrix multiply solution determined by SMT solver 204.

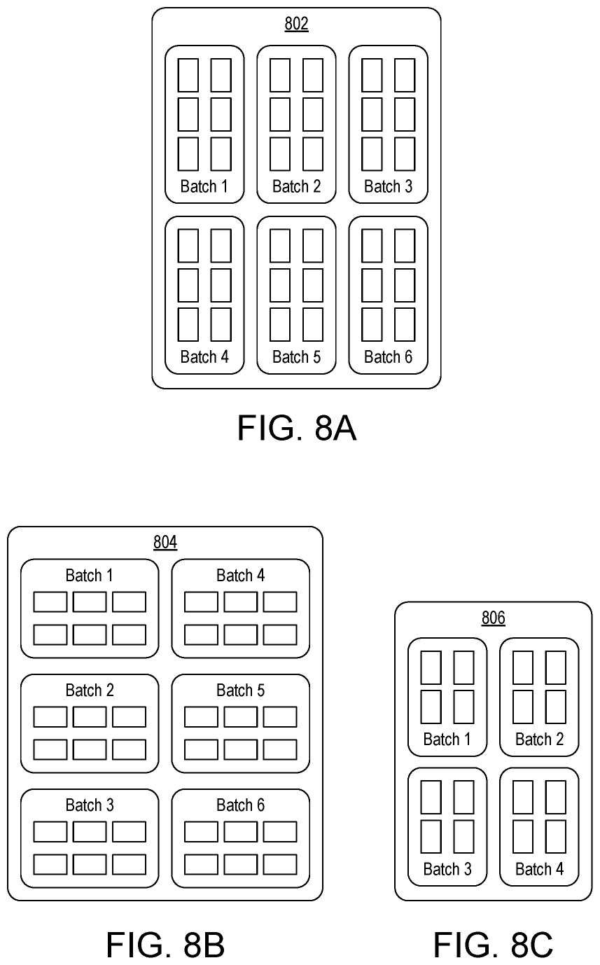

FIGS. 8A, 8B, and 8C illustrate example partitions of matrices A (802), B (804), and C (806), respectively, for a matrix multiply operation. To feed, or provide data to, cores 608 of data processing array 601, each of the operand matrices A and B must be tiled. The tiled (e.g., partitioned) data must be provided to corresponding input ports of data processing array 601. For example, the tiled data must be read from external memory 640 and provided to input ports of data processing array 601 (e.g., ports of array interface 622 located in one or more of the interface tiles 604).

Implementing temporal iterations requires that the input data be fed into data processing array 601 in different batches for each of the input ports. In this regard, the HLS code generator 206 is capable of generating the program code defining interface 632 to handle the partitioning of the input data (operand matrices A and B) and also to reconstruct the result matrix C.

In the examples described herein, when i_tp (e.g., the number of temporal partitions for dimension I) is greater than 1, results obtained from output ports of data processing array 601 for each batch (e.g., batches 1, 2, 3, 4, 5, and 6) are partial. These partial results must be accumulated for the next i_tp batches to get the complete result of one output partition (e.g., batch).

The input data batches get arranged such that temporal iteration partitions across i_tp (where I is the common dimension between matrix A and matrix B) should be fed first on both of the A and B matrices partition inputs. The outputs from data processing array 601 are also captured batchwise. The data from each output port of data processing array 601 may be stored in a memory such as an on-chip RAM. The on-chip RAM may be implemented as part of interface 632. Each RAM for an output port of data processing array 601 stores data in an amount that equals the size of one partitioned data output.

If, for example, i_tp is greater than 1, then i_tp number of batches are added outside the DPE cores for each data processing array 601 output port to compute the complete output of one batch of for matrix C.

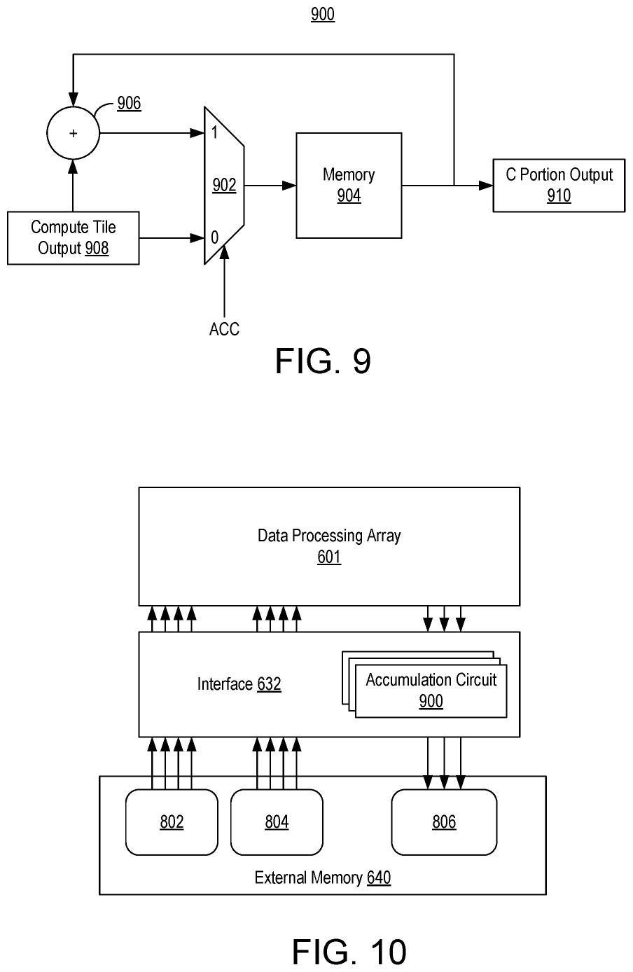

FIG. 9 illustrates an example of accumulation circuit 900 that may be generated based on the matrix multiply solution determined by SMT solver 204. In the example of FIG. 9, accumulation circuit 900 may represent the logic for a single output port of data processing array 601. That is, in cases where the results must be accumulated to generate the complete output for one batch for matrix C, accumulation circuit 900 may be included within interface 632 to each output port of data processing array 601.

In the example of FIG. 9, accumulation circuit 900 includes a multiplexer 902, a memory 904 (e.g., a block RAM, URAM, or other memory primitive or combination of memory primitives), and an adder 906. The control signal ACC provided to multiplexer 902 controls whether the signal from input 0 or the signal from input 1 is passed to memory 904. For cases where no accumulation is needed, e.g., a complete output for one batch is received as compute tile output 908, the ACC signal selects input 0. Accordingly, compute tile output 908 is passed to memory 904 and stored therein. Compute tile output 908 may be output from memory 904 as C portion output 910.

For cases where accumulation is needed, the ACC signal first selects input 0. Accordingly, compute tile output 908 is passed to memory 904 and stored therein. That data is output from memory 904 to adder 906 and added with a next compute tile output 908. In this iteration and each other iteration to complete the output for one batch of matrix C, the ACC control signal selects input 1 so that the accumulated value is stored in memory 904. In response to completing the iterative process for generating a complete output for one batch of matrix C, the accumulated value from memory 904 is output as C portion output 910.

For example, the ACC control signal may be generated by counter logic (not shown) that counts from 0 to i_tp-1. As noted, accumulation circuit 900 represents the logic for one output port and one memory 904. In an actual implementation, there will be v_sp*h_sp memories 904 and the same number of accumulation circuit 900 circuits to capture and accumulate the partial matrix multiplication output from data processing array 601.

After accumulating i_tp number of data from each output port of data processing array 601, one batch of matrix C is available at the v_sp*h_sp number accumulation circuits 900, taken collectively. Interface 632 may include further logic that reorders the results obtained from the respective accumulation circuits 900 and writes the reordered data to external memory 640 to reconstruct matrix C in external memory 640. Such operations may be performed by interface 632 for each batch in matrix C.

FIG. 10 illustrates an example circuit architecture implementing a matrix multiply operation in accordance with the inventive arrangements. As pictured, matrices A, B, and C are stored in external memory 640. Interface 632 is configured to include the number of input ports specified by the matrix multiply solution determined by SMT solver 204 for each of matrix A and matrix B. For example, interface 632 includes v_sp*i_sp number of input ports for matrix A. Interface 632 includes i_sp*h_sp number of input ports for matrix B. Interface 632 is configured to load data according to the partitioning illustrated in partitioned matrices 802 (matrix A) and 804 (matrix B). Further, interface 632 includes a number of output ports for receiving result data from data processing array 601 and, if required based on the matrix multiply solution, the same number of accumulation circuits 900 to reconstruct matrix C. For example, interface 632 includes v_sp*h_sp number of output ports (and if needed the same number of accumulation circuits 900) for matrix C. It should be appreciated that the size of the various input and output ports may be determined according to the size of the data elements of the matrices being operated as given by the datatype parameters.

For purposes of illustration, an example DFG as generated by DFG generator 212 based on matrix multiply solution 220 is illustrated in Listing 3. The example DFG of Listing 3 is partitioned based on matrix multiply solution 220. DFG compiler 214 is capable of using the DFG to define the interconnect and functionality of each compute tile 602. The “xf::dsp::aie::blas::matrix_mult::matrix_mult_graph” is a matrix_mult function provided by the hardware library package used.

Listing 3

```
class aiesynth_mmult1_sg_0_0_graph : public adf::graph
{
public:
  // DPE input/output port definition
  std::vector<adf::port<input> > A;
  std::vector<adf::port<input> > B;
  std::vector<adf::port<output> > Out;
  // matrix mult node definition
  xf::dsp::aie::blas::matrix_mult::matrix_mult_graph<int32, int32, 16,
32, 16, 0, 0, ROW_MAJOR, ROW_MAJOR, ROW_MAJOR, 1, 1, 1,
512, 512, 2> sg_0_0;
  xf::dsp::aie::blas::matrix_mult::matrix_mult_graph<int32, int32, 16,
32, 16, 0, 0, ROW_MAJOR, ROW_MAJOR, ROW_MAJOR, 1, 1, 1,
512, 512, 2> sg_0_1;
  xf::dsp::aie::blas::matrix_mult::matrix_mult_graph<int32, int32, 16,
32, 16, 0, 0, ROW_MAJOR, ROW_MAJOR, ROW_MAJOR, 1, 1, 1,
512, 512, 2> sg_1_0;
  xf::dsp::aie::blas::matrix_mult::matrix_mult_graph<int32, int32, 16,
32, 16, 0, 0, ROW_MAJOR, ROW_MAJOR, ROW_MAJOR, 1, 1, 1,
512, 512, 2> sg_1_1;
  aiesynth_mmult1_sg_0_0_graph( ) : A(4),
    B(4),
    Out(4),
    sg_0_0( ),
    sg_0_1( ),
    sg_1_0( ),
    sg_1_1( )
  {
    adf::kernel *sg_0_0_kernels = sg_0_0.getKernels( );
    for (int i=0; i<2; i++) {
      adf::runtime<ratio>(sg_0_0_kernels[i]) = 0.9;
    }
    adf::kernel *sg_0_1_kernels = sg_0_1.getKernels( );
    for (int i=0; i<2; i++) {
      adf::runtime<ratio>(sg_0_1_kernels[i]) = 0.9;
    }
    adf::kernel *sg_1_0_kernels = sg_1_0.getKernels( );
    for (int i=0; i<2; i++) {
      adf::runtime<ratio>(sg_1_0_kernels[i]) = 0.9;
    }
    adf::kernel *sg_1_1_kernels = sg_1_1.getKernels( );
    for (int i=0; i<2; i++) {
      adf::runtime<ratio>(sg_1_1_kernels[i]) = 0.9;
    }
    // DFG interconnects
    adf::connect<>(A[0] , sg_0_0.inA[0]);
    adf::connect<>(B[0] , sg_0_0.inB[0]);
    adf::connect<>(A[1] , sg_0_0.inA[1]);
    adf::connect<>(B[2] , sg_0_0.inB[1]);
    adf::connect<>(sg_0_0.out , Out[0]);
    adf::connect<>(A[0] , sg_0_1.inA[0]);
    adf::connect<>(B[1] , sg_0_1.inB[0]);
    adf::connect<>(A[1] , sg_0_1.inA[1]);
    adf::connect<>(B[3] , sg_0_1.inB[1]);
    adf::connect<>(sg_0_1.out , Out[1]);
    adf::connect<>(A[2] , sg_1_0.inA[0]);
    adf::connect<>(B[0] , sg_1_0.inB[0]);
    adf::connect<>(A[3] , sg_1_0.inA[1]);
    adf::connect<>(B[2] , sg_1_0.inB[1]);
    adf::connect<>(sg_1_0.out , Out[2]);
    adf::connect<>(A[2] , sg_1_1.inA[0]);
    adf::connect<>(B[1] , sg_1_1.inB[0]);
    adf::connect<>(A[3] , sg_1_1.inA[1]);
    adf::connect<>(B[3] , sg_1_1.inB[1]);
    adf::connect<>(sg_1_1.out , Out[3]);
  }
};
```

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of computer-readable storage media. A non-exhaustive list of examples of computer-readable storage media include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the term “responsive to” and similar language as described above, e.g., “if,” “when,” or “upon,” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the terms “individual” and “user” each refer to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or media) having computer-readable program instructions thereon for causing a processor to carry out aspects of the inventive arrangements described herein. Within this disclosure, the term “program code” is used interchangeably with the term “program instructions.” Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer-readable program instructions may include state-setting data. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer-readable program instructions by utilizing state information of the computer-readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer-readable program instructions, e.g., program code.

These computer-readable program instructions may be provided to a processor of a computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the operations specified in the flowchart and/or block diagram block or blocks.

The computer-readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, using computer hardware, parameters defining a matrix multiply operation to be implemented in a data processing array;
generating, using the computer hardware, a formulation of the matrix multiply operation based on the parameters;
determining, using the computer hardware, a matrix multiply solution for performing the matrix multiply operation in the data processing array, wherein the matrix multiply solution specifies a spatial and temporal partitioning of the matrix multiply operation for implementation in the data processing array; and
generating, using the computer hardware, synthesizable program code defining an interface for the data processing array based on the matrix multiply solution, wherein the interface is configured to partition and transfer input data to the data processing array from an external memory and convey output data from the data processing array to the external memory.

2. The method of claim 1, wherein the formulation is a Satisfiability Modulo Theory (SMT) formulation and the determining the matrix multiply solution is performed by executing an SMT solver with the SMT formulation provided as input.

3. The method of claim 1, further comprising:
synthesizing the synthesizable program code to generate a circuit design for the interface for the data processing array.

4. The method of claim 1, wherein:
for the matrix multiply operation, the input data corresponds to a plurality of operand matrices and the output data corresponds to a result matrix; and
the synthesizable program code defines a number of input ports configured to convey the input data from each operand matrix of the plurality of operand matrices and a number of output ports for conveying the output data of the result matrix.

5. The method of claim 4, wherein the input ports are configured to load corresponding batches of data of each operand matrix from the external memory to the data processing array based on the spatial and temporal partitioning for each input matrix.

6. The method of claim 5, wherein the synthesizable program code defines accumulation circuitry for the output ports.

7. The method of claim 6, wherein the accumulation circuitry is configured to accumulate partial results on the output ports to generate a result batch for each corresponding set of batches of data from the operand matrices.

8. A system, comprising:
one or more hardware processors configured to initiate operations including:
receiving parameters defining a matrix multiply operation to be implemented in a data processing array;
generating a formulation of the matrix multiply operation based on the parameters;
determining a matrix multiply solution for performing the matrix multiply operation in the data processing array, wherein the matrix multiply solution specifies a spatial and temporal partitioning of the matrix multiply operation for implementation in the data processing array; and
generating synthesizable program code defining an interface for the data processing array based on the matrix multiply solution, wherein the interface is configured to partition and transfer input data to the data processing array from an external memory and convey output data from the data processing array to the external memory.

9. The system of claim 8, wherein the formulation is a Satisfiability Modulo Theory (SMT) formulation and the determining the matrix multiply solution is performed by executing an SMT solver with the SMT formulation provided as input.

10. The system of claim 8, wherein the one or more hardware processors are configured to initiate operations further comprising:
synthesizing the synthesizable program code to generate a circuit design for the interface for the data processing array.

11. The system of claim 8, wherein:
for the matrix multiply operation, the input data corresponds to a plurality of operand matrices and the output data corresponds to a result matrix; and
the synthesizable program code defines a number of input ports configured to convey the input data from each operand matrix of the plurality of operand matrices and a number of output ports for conveying the output data of the result matrix.

12. The system of claim 11, wherein the input ports are configured to load corresponding batches of data of each operand matrix from the external memory to the data processing array based on the spatial and temporal partitioning for each input matrix.

13. The system of claim 12, wherein the synthesizable program code defines accumulation circuitry for the output ports.

14. The system of claim 13, wherein the accumulation circuitry is configured to accumulate partial results on the output ports to generate a result batch for each corresponding set of batches of data from the operand matrices.

15. A computer program product comprising one or more computer readable storage mediums having program instructions embodied therewith, the program instructions executable by computer hardware to cause the computer hardware to initiate executable operations comprising:
receiving parameters defining a matrix multiply operation to be implemented in a data processing array;
generating a formulation of the matrix multiply operation based on the parameters;
determining a matrix multiply solution for performing the matrix multiply operation in the data processing array, wherein the matrix multiply solution specifies a spatial and temporal partitioning of the matrix multiply operation for implementation in the data processing array; and
generating synthesizable program code defining an interface for the data processing array based on the matrix multiply solution, wherein the interface is configured to partition and transfer input data to the data processing array from an external memory and convey output data from the data processing array to the external memory.

16. The computer program product of claim 15, wherein the formulation is a Satisfiability Modulo Theory (SMT) formulation and the determining the matrix multiply solution is performed by executing an SMT solver with the SMT formulation provided as input.

17. The computer program product of claim 15, wherein the program instructions are executable by the computer hardware to initiate operations further comprising:
synthesizing the synthesizable program code to generate a circuit design for the interface for the data processing array.

18. The computer program product of claim 15, wherein:
for the matrix multiply operation, the input data corresponds to a plurality of operand matrices and the output data corresponds to a result matrix; and
the synthesizable program code defines a number of input ports configured to convey the input data from each of operand matrix of the plurality of operand matrices and a number of output ports for conveying the output data of the result matrix.

19. The computer program product of claim 18, wherein the input ports are configured to load corresponding batches of data of each operand matrix from the external memory to the data processing array based on the spatial and temporal partitioning for each operand matrix.

20. The computer program product of claim 19, wherein:
the synthesizable program code defines accumulation circuitry for the output ports; and
the accumulation circuitry is configured to accumulate partial results on the output ports to generate a result batch for each corresponding set of batches of data from the operand matrices.
